(19) United States
(12) Patent Application Publication
(10) Pub. No.: US 2019/0348014 A1
(43) Pub. Date: Nov. 14, 2019

(54) PERFORMANCE ASSISTANCE APPARATUS AND METHOD

(71) Applicant: YAMAHA CORPORATION, Hamamatsu-shi (JP)

(72) Inventor: Akemi KUBITA, Hamamatsu-shi (JP)

(21) Appl. No.: 16/522,813

(22) Filed: Jul. 26, 2019

Related U.S. Application Data
(63) Continuation of application No. PCT/JP2018/008100, filed on Mar. 2, 2018.

(30) Foreign Application Priority Data
Mar. 3, 2017 (JP) 2017-040597

(51) Int. Cl. G10G 1/02; G10H 1/00

(52) U.S. Cl. CPC G10G 1/02; G10H 1/0016; G10H 2210/571; G10H 2220/091; G10H 2210/066

(57) ABSTRACT

To assist a human player in performing a foot operator group (pedal keyboard) including a plurality of foot operators operable with a human player's foot, a foot operator image indicative of the foot operator group is displayed on a display screen. Model performance data each designating a pitch to be performed are sequentially acquired, and it is determined whether the pitch designated by the acquired model performance data should be performed by use of the foot operator group. Upon determination that the designated pitch should be performed by use of the foot operator group, a particular foot operator corresponding to the designated pitch is visually designated on the displayed foot operator image (for example by adding a marker image to the particular foot operator). Thus, the human player can easily operate the foot operators while visually confirming, on the foot operator image, each foot operator to be operated.

### CROSS REFERENCE TO RELATED APPLICATIONS

This application is a continuation of PCT International Application No. PCT/JP2018/008100, filed Mar. 2, 2018, which claims priority under 35 U.S.C. § 119 from Japanese Patent Application No. JP PA 2017-040597, filed Mar. 3, 2017, the entire disclosure of which are herein incorporated by reference.

### BACKGROUND

The embodiments of the present invention relate to a performance assistance apparatus and method suited for training of a music performance.

There have heretofore been known electronic musical instruments that have a guide function for guiding a user or human player in a music performance. Such electronic musical instruments have a key depression guide function. The electronic keyboard musical instrument includes LEDs (Light Emitting Diodes) provided in corresponding relation to individual keys of a keyboard. In a guide mode, the LED corresponding to a particular key to be operated is illuminated in a first style a predetermined time before a key-on timing of the key and illuminated in a second style at the key-on timing.

### SUMMARY

Some of the existing electronic musical instruments include, in addition to a manual keyboard operable with hands, a pedal keyboard operable with feet, as typified by electronic organs. The pedal keyboard includes a plurality of pedal keys having different pitches (sound pitches) assigned respectively thereto. In order to enable a user to improve his or her skill for performing the pedal keyboard, it is required to provide the user with a performance guide for the pedal keyboard in addition to a performance guide for the manual keyboard. However, the pedal keyboard is located more remote from the eyes of the user than the manual keyboard. Thus, even in a case where the performance guide for the pedal keyboard is provided using LEDs in a similar manner to the performance guide for the manual keyboard, it may be difficult for the user to appropriately know or identify pedal keys to be operated. If the LEDs for the pedal keyboard are provided at positions near the user's eyes, for example, the LEDs and the pedal keyboard are spaced from each other by a relatively great distance, it may be difficult for the user to associate illuminated LEDs and pedal keys to be operated. If the LEDs for the pedal keyboard are provided at positions near the pedal keyboard, on the other hand, it may be difficult for the user to look at the LEDs. For the foregoing reasons, it tends to be difficult to enable the user to improve his or her skill for performing the pedal keyboard.

In view of the foregoing prior art problems, it is one of the objects of the present invention to provide a performance assistance apparatus and method which can assist a human player in performing a foot operator group by use of a structure that is easy for the human player to look at and thereby effectively enables the human player to improve his or her skill for performing the foot operator group.

In order to accomplish the aforementioned and other objects, the inventive performance assistance apparatus is suited for application to a performance apparatus provided with a foot operator group including a plurality of foot operators that are operable with a foot of a human player and that have different pitches (or sound pitches) assigned respectively thereto, and the inventive performance assistance apparatus includes: a storage medium storing a program; and a processor for executing the program, the processor, when executing the program, configured to: cause a display device to display a foot operator image indicative of the foot operator group; acquire model performance data designating a pitch to be performed; determine whether the pitch designated by the acquired model performance data should be performed by use of the foot operator group; and upon determination that the designated pitch should be performed by use of the foot operator group, visually designate, on the foot operator image displayed on the display device, a particular foot operator of the plurality of foot operators that corresponds to the designated pitch.

According to the inventive performance assistance apparatus constructed in the aforementioned manner, the foot operator image indicative of the foot operator group is displayed on the display device, and a particular foot operator of the plurality of foot operators that corresponds to the pitch designated by the model performance data is visually designated (indicated) on the foot operator image. In this way, the display device can be disposed at a position easy for the human player to look at, without being constrained by a physical position of the foot operator group (such as a pedal keyboard). Thus, the inventive performance assistance apparatus can assist the human player in performing the foot operator group, with a structure easy for the human player to look at. Further, because the foot operator image indicative of the foot operator group is displayed on the display device, the human player can not only intuitively know or identify the position of each of the foot operators to be operated, by looking at the foot operator image, but also easily associate each pitch to be performed and any one of the foot operators to be operated. In this way, the inventive performance assistance apparatus can appropriately assist the human player in performing the foot operator group as he or she should, without being constrained by the physical position of the foot operator group. As a result, in the case where the inventive performance assistance apparatus is applied to performance training of the foot operator group, the inventive performance assistance apparatus effectively enables the human player to improve his or her skill for performing the foot operator group.

The disclosure made herein also embraces a method that includes steps corresponding to the constituent elements of the inventive performance assistance apparatus set forth above. The method may be arranged as a computer-implemented method. Also disclosed herein is a computer-readable, non-transitory storage medium storing a program executable by one or more processors for performing the aforementioned method.

### BRIEF DESCRIPTION OF DRAWINGS

Certain embodiments of the present invention will hereinafter be described in detail, by way of example only, with reference to the accompanying drawings, in which:

FIG. 1 is a block diagram illustrating an example of a hardware construction of an electronic musical instrument provided with an embodiment of the inventive performance assistance apparatus;

FIG. 2 is a schematic diagram explanatory of a specific example of each of a manual keyboard and a pedal keyboard that constitute a performance operator unit, and a guide section;

FIG. 3 is a diagram illustrating an example of a training screen displayed on a display;

FIG. 4 is a block diagram illustrating a functional configuration of the performance assistance apparatus;

FIG. 5 is a flow chart illustrating an example of a portion of training processing performed in the performance assistance apparatus;

FIG. 6 is a flow chart illustrating an example of the remaining portion of the training processing performed in the performance assistance apparatus; and

FIG. 7 is a diagram illustrating a performance apparatus including another type of foot operator group.

### DETAILED DESCRIPTION

Construction of Electronic Musical Instrument

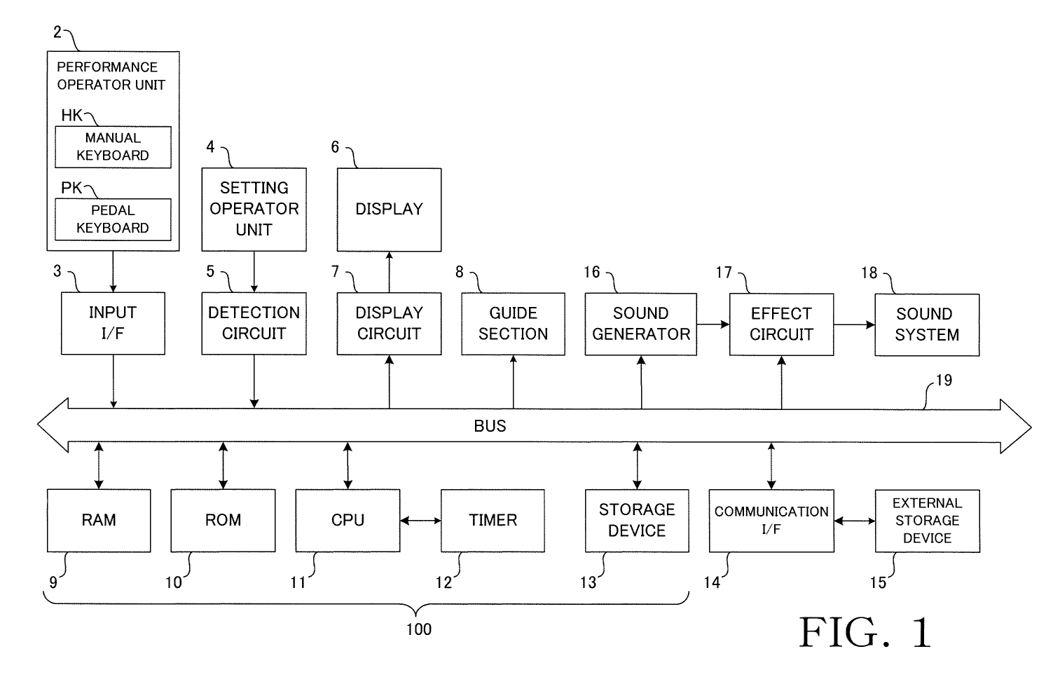

FIG. 1 is a block diagram illustrating an example of a hardware construction of an electronic musical instrument 1 provided with an embodiment of the inventive performance assistance apparatus 100. The electronic musical instrument 1 of FIG. 1 is an electronic keyboard musical instrument capable of performing music pieces. As an operation mode of the electronic musical instrument 1, a training mode is available for executing music performance training by use of a function of the performance assistance apparatus 100 incorporated in the electronic musical instrument 1.

The electronic musical instrument 1 includes a performance operator unit 2, an input I/F (interface) 3, a setting operator unit 4, a detection circuit 5, a display 6, a display circuit 7, and a guide section 8. The performance operator unit 2 is connected to a bus 19 via the input I/F 3. Performance data are input to the electronic musical instrument 1 by a user operating the performance operator unit 2. The performance data are, for example, in the form of MIDI (Musical Instrument Digital Interface) data or audio data. In the illustrated example, the performance operator unit 2 includes a manual keyboard HK (manual operator group) suited for operation with user's (human player's) hands and a pedal keyboard PK (foot operator group) suited for operation with a foot or feet of the user. Details of the manual keyboard HK and pedal keyboard PK will be set forth later.

The setting operator unit 4 includes an ON/OFF operation switch, a rotationally operable rotary encoder or a slidingly operable linear encoder, and the like, and this setting operator unit 4 is connected to the bus 19 via the detection circuit 5. The setting operator unit 4 is used to execute sound volume adjustment, turning-ON/OFF of a power supply, and various other settings. The display 6 is a display device generally known as a peripheral device of a computer or the like and includes a flat screen having a necessary and sufficient area. The display 6 includes, for example, a liquid crystal display and is connected to the bus 19 via the display circuit 7. Various information related to a performance, settings, and the like is displayed on the display 6. At least portions of the setting operator unit 4 and display 6 may be constituted by a touch panel display. As generally known, the display 6 is disposed at a position (for example, at an eye level position) that is easy for the user (human player) to look at. Namely, the position of the display 6 is not constrained by a physical position of the pedal keyboard PK. The guide section 8 guides the user or human player in a performance executed using the performance operator unit 2. Details of the guide section 8 will be set forth later.

The electronic musical instrument 1 further includes a RAM (Random Access Memory) 9, a ROM (Read-Only Memory) 10, a CPU (Central Processing Unit) 11, a timer 12, and a storage device 13. The RAM 9, ROM 10, CPU 11, and storage device 13 are connected to the bus 19, and the timer 12 is connected to the CPU 11. External equipment, such as an external storage device 15, may be connected to the bus 19 via a communication I/F (interface) 14. The RAM 9, ROM 10, CPU 11, and timer 12 together constitute a computer.

The RAM 9, which is for example a volatile memory, is used as a working area for the CPU 11 but also temporarily stores various data. The ROM 10, which is for example a non-volatile memory, has stored therein computer programs (application programs), such as control programs and the performance assistance program. The CPU 11 performs later-described performance training processing by executing on the RAM 9 the performance assistance program stored in the ROM 10. The timer 12 gives time information, such as a current time, to the CPU 11.

The storage device 13 includes any of storage media, such as a hard disk, an optical disk, a magnetic disk, and a memory card, to store music piece data sets of a plurality of practice music pieces. Each of the sets of practice music piece data (music piece data sets) includes a plurality of part data corresponding to a plurality of performance parts. Each of the part data, which is for example in the form of MIDI data, includes a plurality of event data indicative of a train of pitches, note-on and note-off time points, velocities, and the like of the corresponding performance part.

The aforementioned performance assistance program may be stored in the storage device 13. Similarly to the storage device 13, the external storage device 15 includes any of storage media, such as a hard disk, an optical disk, a magnetic disk, and a memory card. The aforementioned performance assistance program may be stored in the external storage device 15.

The performance assistance program may be stored in a computer-readable storage medium and supplied in the storage medium to be installed into the ROM 10 or storage device 13. Further, in a case where the communication I/F 14 is connected to a communication network, the performance assistance program delivered from a server connected to the communication network may be installed into the ROM 10 or storage device 13. Similarly, at least one of the music piece data sets may be acquired from a storage medium or acquired from a server connected to the communication network.

The electronic musical instrument 1 further includes a sound generator 16, an effect circuit 17, and a sound system 18. The sound generator 16 and effect circuit 17 are connected to the bus 19, and the sound system 18 is connected to the effect circuit 17. The sound generator 16 generates tone signals on the basis of performance data input via the performance operator unit 2 and part data of a later-described automatic performance part. The effect circuit 17 imparts acoustic effects to the tone signals generated by the sound generator 16.

The sound system 18 includes a digital-to-analog (D/A) conversion circuit, an amplifier, and a speaker. The sound system 18 converts into an analog sound signal a tone signal supplied from the sound generator 16 via the effect circuit 17 and generates a sound based on the analog sound signal. The electronic musical instrument 1 as a whole functions as a performance apparatus that generates a tone in response to a user's performance operation on the performance operator unit 2. Further, in the electronic musical instrument 1, the display 6, RAM 9, ROM 10, CPU 11, and storage device 13 mainly function as the performance assistance apparatus 100.

Performance Operator Unit and Guide Section

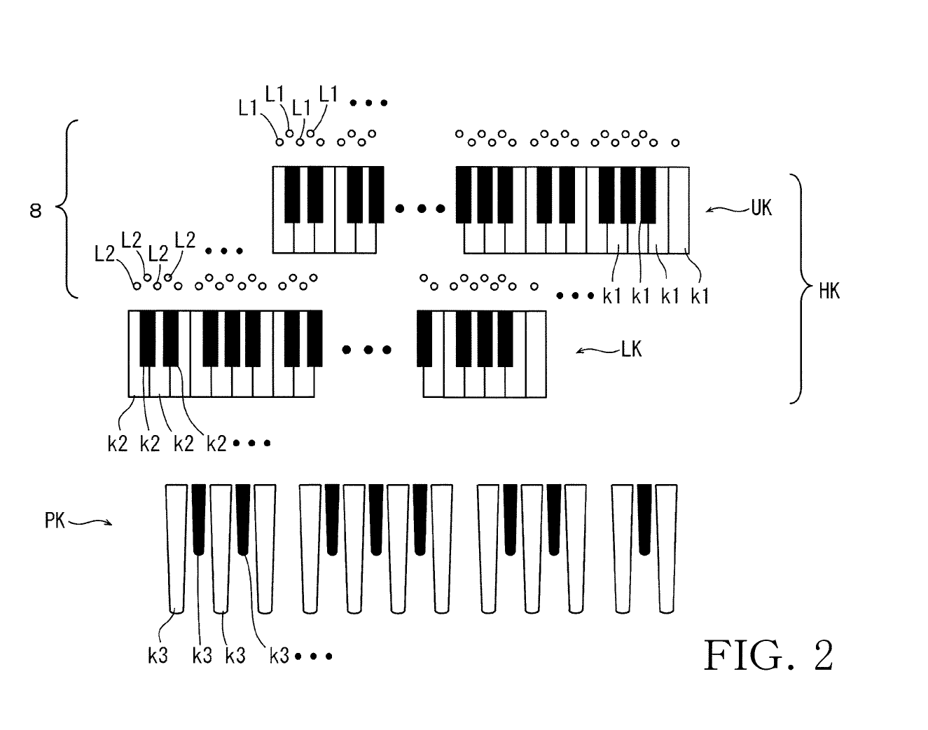

FIG. 2 is a schematic diagram explanatory of a specific example of each of the manual keyboard HK and pedal keyboard PK constituting the performance operator unit 2 and the guide section 8. As illustrated in FIG. 2, the manual keyboard HK includes an upper keyboard UK and a lower keyboard LK. The upper keyboard UK and lower keyboard LK are positionally displaced from each other in an up-down direction and in a front-rear direction. More specifically, the upper keyboard UK is located above the lower keyboard LK and rearward of the lower keyboard LK (namely, located more remote from the user than the lower keyboard LK). The upper keyboard UK is suited mainly for operation with the user's right hand, while the lower keyboard LK is suited mainly for operation with the user's left hand. The upper keyboard UK includes a plurality of upper keys k1 having different pitches assigned respectively thereto, and the lower keyboard LK includes a plurality of lower keys k2 having different pitches assigned respectively thereto. The pedal keyboard PK includes a plurality of pedal keys k3 having different pitches assigned respectively thereto. Hereinafter, the upper keys k1 and lower keys k2 will be referred to collectively as manual keys.

The upper keyboard UK includes, for example, forty-nine upper keys k1 (namely, four octaves and one note) or sixty-one upper keys k1 (namely, five octaves and one note). Similarly to the upper keyboard UK, the lower keyboard LK includes forty-nine or sixty-one lower keys k2. The pedal keyboard PK includes, for example, twenty pedal keys k3 (namely, one octave and eight notes) or twenty-five pedal keys k3 (namely, two octaves and one note). Generally, the lowest pitch in the pitch range of the lower keyboard LK is higher than the lowest pitch in the pitch range of the pedal keyboard PK, and the lowest pitch in the pitch range of the upper keyboard UK is higher than the lowest pitch in the pitch range of the lower keyboard LK. Further, the pitch range of the pedal keyboard PK is narrower than the pitch range of each of the upper keyboard UK and lower keyboard LK. The respective pitch ranges of the upper keyboard UK, lower keyboard LK, and pedal keyboard PK may be set in advance or may be set as desired by the user.

Further, in the example illustrated in FIG. 2, the guide section 8 includes a plurality of upper illumination portions L1 corresponding to the individual upper keys k1 and a plurality of lower illumination portions L2 corresponding to the individual lower keys k2. Each of the upper illumination portions L1 and lower illumination portions L2 is constituted, for example, by an LED (Light Emitting Diode). For example, the individual upper illumination portions L1 are provided on a rear panel surface portion of the upper keyboard UK in such a manner that the illumination portions L1 adjoin the corresponding upper keys k1 in the front-rear direction. The individual lower illumination portions L2 are provided on a panel surface portion located between the upper keyboard UK and the lower keyboard LK in such a manner that the illumination portions L2 adjoin the corresponding lower keys k2 in the front-rear direction. In the training mode, any one of the upper illumination portions L1 is illuminated at a time point when the corresponding upper key k1 should be operated, and any one of the lower illumination portions L2 is illuminated at a time point when the corresponding lower key k2 should be operated. In this way, the user can easily know or identify the operating time point of each of the upper keys k1 and lower keys k2. Note that the guide section 8 may include only one of the groups of the upper illumination portions L1 and lower illumination portions L2. In such a case, the guide section 8 guides the user in a performance on only one of the upper keyboard UK and the lower keyboard LK.

Training Screen

In the present example, one of the plurality of practice music pieces prepared in advance is selected by the user in the training mode. Further, any of the plurality of performance parts of the selected music piece that is to be performed by the user is selected as practice performance parts. The practice performance part includes at least one of a performance part to be performed on the upper keyboard UK (hereinafter referred to as “upper performance part”), a performance part to be performed on the lower keyboard LK (hereinafter referred to as “lower performance part”), and a performance part to be performed on the pedal keyboard PK (hereinafter referred to as “pedal performance part”). Note that at least one of the upper performance part, lower performance part, and pedal performance part may be set in advance as the practice performance part.

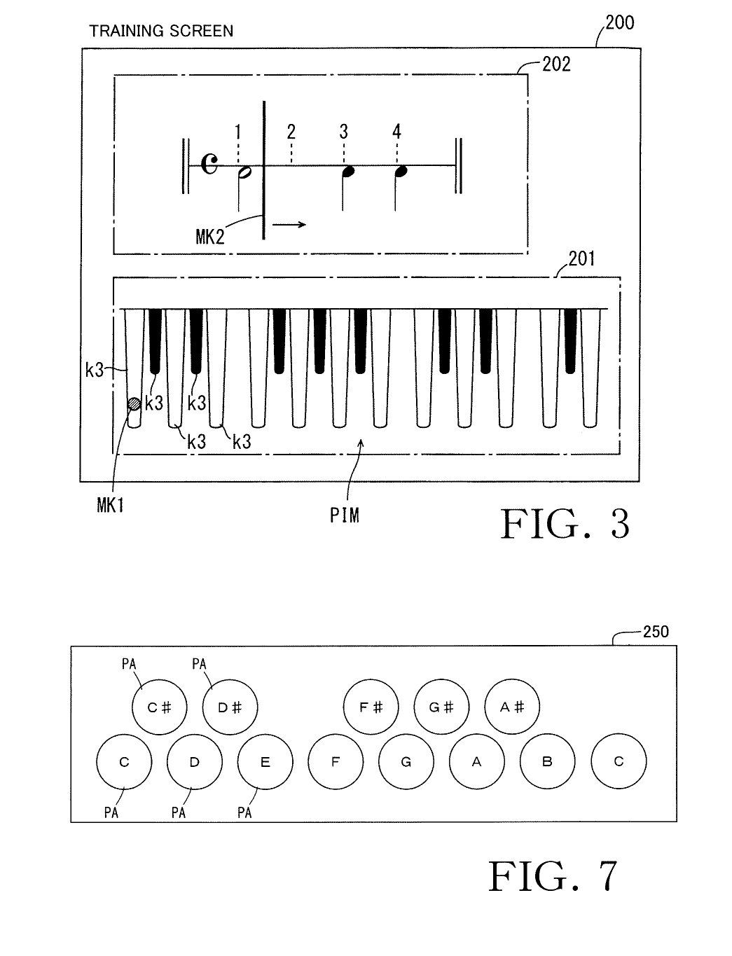

In accordance with a progression of the selected music piece, a guide is provided for assisting the user in performing each of the practice performance parts. A training screen for guiding the user in a performance on the pedal keyboard PK is displayed on the display 6 of FIG. 1. FIG. 3 is a diagram illustrating an example of the training screen 200 displayed on the display 6. In FIG. 3, the training screen 200 includes a pedal keyboard image display region 201 and a rhythm information display region 202. A pedal keyboard image PIM corresponding to the pedal keyboard PK of FIG. 2 is displayed on the pedal keyboard image display region 201. The pedal keyboard image PIM of FIG. 3 corresponds to the pedal keyboard PK having twenty keys.

In accordance with the progression of the music piece, the pedal keys k3 to be operated are sequentially designated on the pedal keyboard image PIM. In the present example, a circular marker MK1 is additionally displayed on the image of the pedal key k3 to be operated. Note that an arrow or the like pointing to the pedal key k3 to be operated may be additionally displayed in place of the marker MK1. In short, in order to designate (or highlight or provide a visual guide for) the pedal key k3 to be operated, it suffices that a particular icon be additionally displayed in relation to the image of the pedal key k3 to be operated. As another example, a display style of the image of the pedal key k3 to be operated may itself be changed in order to designate (or highlight or provide a visual guide for) the pedal key k3. For example, a color of the image of the pedal key k3 to be operated may be changed, or the image of the pedal key k3 to be operated may be displayed in a blinking manner.

Rhythm information indicative of a rhythm of the pedal performance part is displayed on the rhythm information display region 202 per predetermined section of the selected music piece. In the illustrated example of FIG. 3, a rhythm score of one measure including a position of the music piece at a current time (hereinafter referred to as “current position”) is displayed as the rhythm information. A marker MK2 indicative of the current position is displayed on the rhythm score. In the illustrated example of FIG. 3, it is indicated by the marker MK2 that the current position is between first and second beats. The marker MK2 is moved as the music piece progresses. Once the current position indicated by the marker MK2 reaches the end of the currently displayed measure, the measure display on the rhythm information display region 202 switches to the next measure.

Generally, a bass part is assigned as the pedal performance part. In the bass part, a same pitch (for example, root note of a chord) is often placed in succession. In such a case, a same key k3 is designated repeatedly on the pedal keyboard image PIM. Thus, start and end time points of the individual notes are difficult to be identified, particularly visually, and consequently, it tends to be difficult for the user to identify the rhythm of the pedal performance part if the user is inexperienced. Thus, in the illustrated example, the rhythm information is displayed together with the pedal keyboard image PIM. In such a case, even where a same pitch is repeated in the pedal performance part, the user can easily identify the rhythm of the pedal performance part. In this way, the user can appropriately perform the pedal performance part.

Functional Configuration

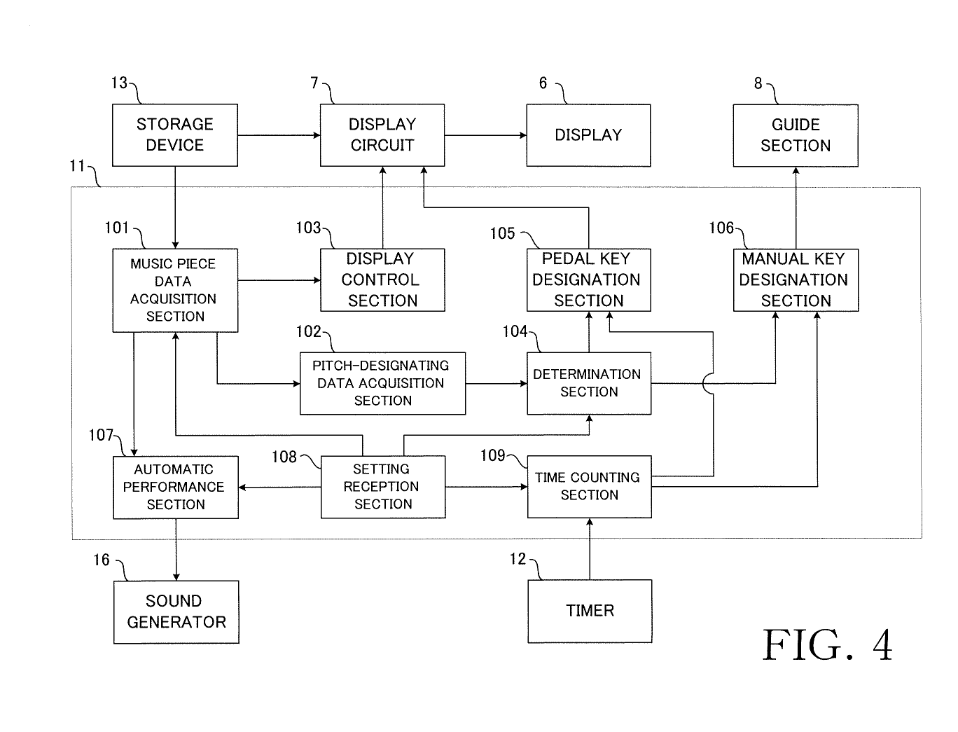

FIG. 4 is a block diagram illustrating a functional configuration of the performance assistance apparatus 100. Functions of various sections of the performance assistance apparatus 100 illustrated in FIG. 4 are performed by the CPU 11 of FIG. 1 executing the performance assistance program stored in the Rom 10 or storage device 13. As illustrated in FIG. 4, the performance assistance apparatus 100 includes a music piece data acquisition section 101, a pitch-designating data acquisition section 102, a display control section 103, a determination section 104, a pedal key designation section 105, a manual key designation section 106, an automatic performance section 107, a setting reception section 108, and a time counting section 109.

The music piece data acquisition section 101 acquires a music piece data set of a music piece selected by the user from among the plurality of music piece data sets stored in the storage device 13. The pitch-designating data acquisition section 102 sequentially acquires pitch-designating data each designating a pitch to be performed (namely, sequentially acquires model performance data). In the illustrated example, the pitch-designating data acquisition section 102 acquires, as the pitch-designating data, pitch-including event data from the part data of the selected practice music piece included in the plurality of part data of the acquired music piece data set. The display control section 103 controls the display circuit 7 to display the pedal keyboard image PIM on the display 6. As conventionally known in the art, the sequential acquisition, by the pitch-designating data acquisition section 102, of the pitch-designating data may be executed under automatic performance sequence control in accordance with a predetermined or user-set performance tempo. At that time, the pitch-designating data acquisition section 102 may sequentially acquire the pitch-designating data at appropriate time points ahead of respective actual sound generation timings as known in the art, because the sequential acquisition of the pitch-designating data is executed in order to provide a performance-assisting guide display. The music piece data acquisition section 101 and the pitch-designating data acquisition section 102 together function as an acquisition section that acquires model performance data designating a pitch to be performed.

The determination section 104 determines whether or not the pitch designated by the acquired pitch-designating data should be performed by use of the pedal keyboard PK. More specifically, the determination section 104 determines which of the manual keyboard HK and pedal keyboard PK should be used to perform the pitch designated by the acquired pitch-designating data. In the illustrated example, when the pitch-designating data has been acquired from the part data of the pedal performance part, the determination section 104 determines that the pitch designated by the pitch-designating data should be performed by use of the pedal keyboard PK. When the pitch-designating data has been acquired from the part data of the upper performance part or lower performance part, on the other hand, the determination section 104 determines that the pitch designated by the pitch-designating data should be performed by use of the manual keyboard HK.

Upon determination that the pitch designated by the pitch-designating data should be performed by use of the pedal keyboard PK, the pedal key designation section 105 visually designates, on the pedal keyboard image PIM, a particular one of the pedal keys k3 that corresponds to the designated pitch. Namely, the marker MK1 is added to the image of the particular pedal key k3, as illustrated for example in FIG. 3. In this manner, the performance assistance unique to the present invention is provided which visually guides, by use of the pedal keyboard image PIM, the user about the particular pedal key k3 to be operated for the music piece performance. Further, upon determination that the pitch designated by the pitch-designating data should be performed by use of the upper keyboard UK or lower keyboard LK, the manual key designation section 106 designates one of the manual keys that corresponds to the designated pitch. In the illustrated example, upon determination that the designated pitch should be performed by use of the upper keyboard UK, the manual key designation section 106 illuminates one of the upper illumination portions L1 that corresponds to the upper key k1 having the designated pitch assigned thereto. Further, upon determination that the designated pitch should be performed by use of the lower keyboard LK, the manual key designation section 106 illuminates one of the lower illumination portions L2 that corresponds to the lower key k2 having the designated pitch assigned thereto. In this manner, the conventionally known performance assistance is provided which visually guides the user about the particular manual key to be operated.

Further, the automatic performance section 107 reproduces an automatic performance by outputting to the sound generator 16 the part data of at least one performance part other than the practice performance part from among the acquired part data of the plurality of performance parts of the selected music piece. The performance part reproduced as the automatic performance will hereinafter be referred to as “automatic performance part”. Such an automatic performance part may be selected by the user or determined in advance. Alternatively, all of the performance parts other than the practice performance part may be automatically set as the automatic performance parts. As conventionally known in the art, a performance tempo of the automatic reproduction by the automatic performance section 107 is interlocked with the above-mentioned performance tempo in the pitch-designating data acquisition section 102.

The setting reception section 108 receives various initial settings. For example, color (sound color or timbre) designations of the individual performance parts, a designation of an initial tempo, a selection of a practice performance part, and the like are received as the initial settings. In a case where the training mode has a plurality of sub-modes, the setting reception section 108 may receive a selection of any one of the sub-modes as an initial setting. The sub-modes include a sub-mode in which the music piece does not progress until the user operates a key to be operated, a sub-mode in which the music piece progresses irrespective of a user's performance, and the like. Further, presence/absence of a rhythm information display on the training screen may be selected as an initial setting.

The time counting section 109 counts a performance time on the basis of clock signals generated by the timer 12 in accordance with a progression of a music piece. The current position in the music piece is indicated by the time counted by the time counting section 109. Note that when a mode in which the progression of the music piece is stopped in response to a user's performance is currently selected as a sub-mode of the training mode, the time counting section 109 temporarily stops the time counting during the entire time period that the progression of the music piece is stopped.

Training Processing

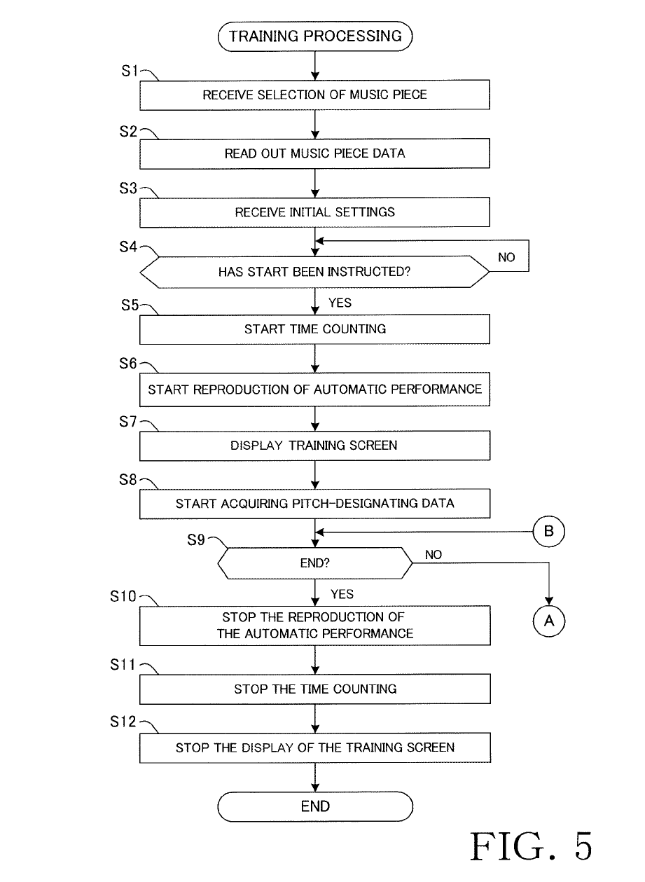

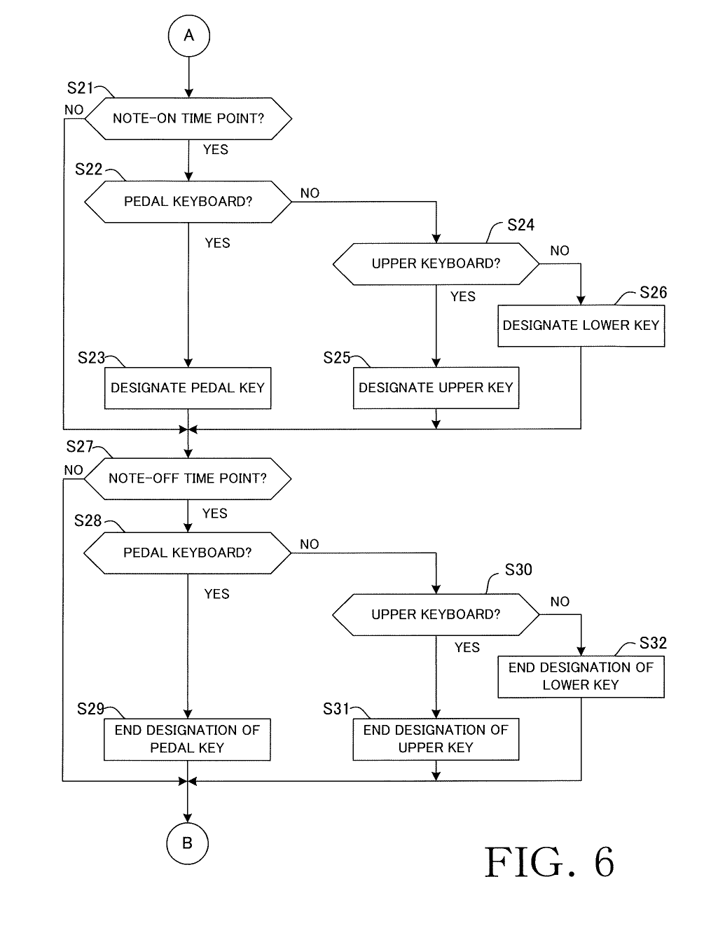

FIGS. 5 and 6 are a flow chart illustrating an example of training processing performed by the performance assistance apparatus 100. When the training mode is selected, the training processing of FIGS. 5 and 6 is performed by the CPU 11 of FIG. 1 executing the performance assistance program stored in the ROM 10 or storage device 13. Note that in the illustrated example of FIGS. 5 and 6, each of the upper performance part, lower performance part, and pedal performance part is selected as the practice performance part.

First, the CPU 11 executes the function of the music piece data acquisition section 101 to receive a selection of a music piece (step S1) and read out the music piece data set of the selected music piece (step S2). For example, once the user selects a music piece by operating the setting operator unit 4 of FIG. 1, the music piece data set of the selected music piece is read out by the function of the music piece data acquisition section 101.

Then, the CPU 11 executes the function of the setting reception section 108 to receive various initial settings (step S3). Next, the CPU 11 executes the function of the time counting section 109 to determine whether or not a start of training has been instructed (step S4). For example, the setting operator unit 4 may include a start button such that a start of training is instructed by the user operating the start button.

Step S4 is repeated until a start of training is instructed. Once a start of training is instructed, the CPU 11 executes the function of the time counting section 109 to start the time counting by the timer 12 of FIG. 1 (step S5). Further, the CPU 11 executes the function of the automatic performance section 107 to start reproduction of an automatic performance on the basis of the part data of the automatic performance part from among the plurality of part data included in the music piece data set read out at step S2 (step S6). Further, the CPU 11 executes the function of the display control section 103 to control the display circuit 7 to display on the display 6 the training screen including the pedal keyboard image PIM (step S7). Furthermore, the CPU 11 executes the function of the pitch-designating data acquisition section 102 to start acquiring pitch-designating data from the part data of each of the practice performance parts (step S8).

Then, the CPU 11 executes the function of the time counting section 109 to determine whether or not the training should be ended (step S9). For example, once the end time point of the selected music piece arrives, it is determined that the training should be ended. Alternatively, the setting operator unit 4 may include a stop button such that it is determined, in response to the user operating the end button, that the training should be ended.

When the training should be ended, the CPU 11 executes the function of the automatic performance section 107 to stop the reproduction of the automatic performance (step S10) and stop the time counting by the time counting section 109 (step S11). Further, the CPU 11 executes the function of the display control section 103 to control the display circuit 7 to stop the display of the training screen on the display 6 (step S12). In this manner, the training processing is ended.

Upon determination at step S9 that the training should not be ended, the CPU 11 goes to the flow portion of FIG. 6. At step S21 of FIG. 6, the CPU 11 executes the function of the pitch-designating data acquisition section 102 to sequentially acquire event data (including pitch-designating data) in accordance with performance timings as well known in the field of automatic performance sequence control, and then the CPU 11 determines, on the basis of the acquired pitch-designating data, whether or not any note-on time point (namely, note-on event) has arrived. If no note-on time point has arrived, steps S22 to S26 to be described below are skipped. Once any note-on time point arrives, the CPU 11 executes the function of the determination section 104 to determine whether or not the pitch in question should be performed by operating the pedal keyboard PK (step S22). If the pitch in question has been designated by the pitch-designating data acquired from the part data of the pedal performance part, it is determined at step S22 that the pitch in question should be performed by operating the pedal keyboard PK. In such a case, the CPU 11 executes the function of the pedal key designation section 105 to visually designate on the pedal keyboard image PIM a particular one of the keys k3 that corresponds to the pitch in question (step S23). Namely, the marker MK1 is added to the image of the particular key k3, as illustrated for example in FIG. 3.

Upon determination at step S22 that the pitch in question should not be performed by use of the pedal keyboard PK, the CPU 11 goes to step S24, where the CPU 11 executes the function of the determination section 104 to further determine whether or not the pitch in question should be performed by use of the upper keyboard UK. If the pitch in question has been designated by the pitch-designating data acquired from the part data of the upper performance part, it is determined at step S24 that the pitch in question should be performed by use of the upper keyboard UK. In such a case, the CPU 11 executes the function of the manual key designation section 106 to designate the upper key k1 corresponding to the pitch in question (step S25). More specifically, the CPU 11 illuminates the upper illumination portion L1 corresponding to the upper key k1 having the pitch in question assigned thereto.

If it is determined at step S24 that the pitch in question should not be performed by use of the upper keyboard UK, this means that the pitch in question should be performed by use of the lower keyboard LK. In such a case, the CPU 11 executes the function of the manual key designation section 106 to designate the lower key k1 corresponding to the pitch in question (step S26). More specifically, the CPU 11 illuminates the lower illumination portion L2 corresponding to the lower key k2 having the pitch in question assigned thereto.

Then, the CPU 11 determines, on the basis of the acquired pitch-designating data, whether or not any note-off time point (namely, note-off event) of a sound of the practice performance part that is currently in an ON state has arrived (step S27). Once such a note-off time point arrives as determined at step S27, the CPU 11 executes the function of the determination section 104 to determine whether the pitch in question is a pitch having so far been performed by use of the pedal keyboard PK (step S28). With a YES determination at step S28, the CPU 11 goes to step S29, where the CPU 11 ends the designation, having so far been made on the pedal keyboard image PIM, of the pedal key corresponding to the pitch in question and then reverts to step S9 of FIG. 5.

Upon determination that the pitch in question corresponding to the note-off event is not a pitch having so far been performed by use of the pedal keyboard PK, on the other hand, the CPU 11 goes to step S30, where the CPU 11 executes the function of the determination section 104 to determine whether or not the pitch in question is a pitch having so far been performed by use of the upper keyboard UK. With a YES determination at step S30, the CPU 11 goes to step S31, where the CPU 11 ends the designation of the upper key k1 corresponding to the pitch in question. More specifically, the CPU 11 turns off the upper illumination portion L1 corresponding to the upper key k1 having the pitch in question assigned thereto and then reverts to step S9 of FIG. 5.

Further, if the pitch in question corresponding to the note-off event is not a pitch having so far been performed by use of the upper keyboard UK as determined at step S30, namely, if a NO determination is made at step S30, this means that the pitch in question is a pitch having so far been performed by operating the lower keyboard LK. In such a case, the CPU 11 goes to step S32, where the CPU 11 ends the designation of the lower key k2 corresponding to the pitch in question. More specifically, the CPU 11 turns off the lower illumination portion L2 corresponding to the lower key k2 having the pitch in question assigned thereto and then reverts to step S9 of FIG. 5.

### Advantages of Embodiment

In the present embodiment of the inventive performance assistance apparatus 100, upon determination that the pitch designated by the pitch-designating data (model performance data) should be performed by use of the pedal keyboard, the pedal key k3 corresponding to the designated pitch is visually designated on the pedal keyboard image PIM. Thus, by looking at the pedal keyboard image PIM, the user (or human player) can intuitively know or identify the pedal key k3 to be operated. Also, the user can easily associate the pitch to be performed and the pedal key k3 to be operated. In this way, the present embodiment of the inventive performance assistance apparatus 100 can appropriately assist the human player in performing the pedal keyboard PK and thereby effectively enables the human player to improve his or her skill for performing the pedal keyboard PK.

Further, in the present embodiment of the inventive performance assistance apparatus 100, upon determination by the determination section 104 that the designated pitch should be performed by operating the manual keyboard HK, the upper key k1 or lower key k2 corresponding to the designated pitch is designated by the guide section 8. Thus, the user can easily know or identify the upper key k1 or lower key k2 to be operated together with the pedal key k3 to be operated. In this way, the user is enabled to improve his or her skill for performing the manual keyboard HK in addition to the skill for performing the pedal keyboard PK.

### Other Embodiments

Although the manual keyboard HK in the above-described embodiment includes two rows of keyboards, the upper keyboard UK and lower keyboard LK, vertically divided from each other, the manual keyboard HK may include only one row of keyboard. In such a case, only one performance part may be selected as a practice performance part of the manual keyboard HK. Alternatively, one row of keyboard may be made dividable into a plurality of key regions. For example, such one row of keyboard may be divided in a left-right direction into a key region for an accompaniment performance and a key region for a melody performance. In such a case, one performance part may be selected for each of the key regions.

Although each manual key to be operated is designated by any one of the upper illumination portions L1 and lower illumination portions L2 in the above-described embodiments, each manual key to be operated may be designated in another desired manner. For example, a manual keyboard image corresponding to the manual keyboard HK may be displayed on the display 6 in such a manner that each manual key to be operated can be designated on the displayed manual keyboard image.

Further, whereas the above-described electronic musical instrument 1 includes the manual keyboard HK as an example of the manual operator group, the electronic musical instrument 1 may include one or more other manual operators in place of or in addition to the manual keyboard HK. Examples of the other manual operators include a modulation wheel, pitch bend wheel, touch pad, and the like. In such a case, in the training mode, any of the manual operators to be operated may be designated on the display 6 or by LEDs in order to guide the user in operating the other manual operators.

Furthermore, although in the above-described embodiments, it is determined, based on which of the part data the pitch-designating data has been acquired from, which of the pedal keyboard PK and manual keyboard HK should be used to perform the pitch designated by the pitch-designating data, the way of making such a determination is not limited to the aforementioned. For example, a pitch range to be performed by use of the pedal keyboard PK and a pitch range to be performed by use of the manual keyboard HK may be set, and, based on which of the thus-set pitch ranges the designated pitch belongs to, it may be determined which of the pedal keyboard PK and manual keyboard HK should be used to perform the designated pitch.

Alternatively, guide information for providing a performance guide may be acquired from the music piece data, and a keyboard to be operated may be determined on the basis of the acquired guide information. For example, as the guide information, keyboard designating information designating the upper keyboard UK may be acquired together with a message indicative of illumination ON/OFF time points, in the music piece, of the upper illumination portions L1. In such a case, it is determined, on the basis of the acquired keyboard information, that the keyboard to be operated is the upper keyboard UK.

Although in the above-described embodiments, the pedal keyboard PK is used as an example of the foot operator group to be operated with the user's feet, another type of foot operator group may be used in place of the pedal keyboard PK. FIG. 7 is a diagram illustrating a performance apparatus including such another type of foot operator group. The performance apparatus 250 of FIG. 7 includes, as an example of the foot operator group, a plurality of operating pads PA operable with the user's feet. Different pitches are assigned respectively to the operating pads PA. In FIG. 7, the pitches assigned to the individual operating pads PA are indicated on the operating pads PA. In the case where the performance apparatus 250 of FIG. 7 is employed, a foot operator group image corresponding to the plurality of operating pads PA is displayed on the display. Further, each operating pad PA to be operated is designated on the displayed foot operator group image.

Further, another type of manual operator group, including a plurality of operating pads that are for example similar to the operating pads of FIG. 7, may be used in place of the manual keyboard HK. Furthermore, a plurality of virtual operators displayed on a touch display panel may be used as the foot operator group or manual operator group.

In the above-described embodiments, the individual functional sections of FIG. 4 are implemented by hardware, such as the CPU 11 of FIG. 1, and software, such as the performance assistance program. Namely, in the embodiment illustrated in FIGS. 1, 5, 6, and the like, a main construction that implements the inventive performance assistance apparatus and/or method is provided by the CPU 11 (namely, processor) executing a necessary application program stored in the RAM 9, ROM 10, or storage device 13 (namely, memory). More specifically, the inventive performance apparatus includes the processor (CPU 11), and the CPU 11 is configured to execute: displaying on the display device (6) the foot operator image (PIM) indicative of the foot operator group (PK) (operation of step S7); acquiring the model performance data designating a pitch to be performed (operations of steps S8 and S21); determining whether the pitch designated by the acquired model performance data should be performed by use of the foot operator group (PK) (operation of step S22); upon determination that the designated pitch should be performed by use of the foot operator group (PK), visually designating, on the foot operator image (PIM) displayed on the display device (6), a particular one of the foot operators that corresponds to the designated pitch (operation of step S23). However, the inventive performance assistance apparatus is not so limited, and the individual functional sections illustrated in FIG. 4 may be implemented by a hardware device designed, using electronic circuitry etc., exclusively for the performance assistance purposes.

Although the embodiments of the present invention have been described above in relation to the case where the present invention is applied to the electronic musical instrument 1 including the display 6, the present invention may be applied to an electronic musical instrument connectable (capable of communicating) with an external display device of a smartphone, tablet terminal, or the like. In such a case, the electronic musical instrument 1 is communicatably connected with the external display device of the smartphone, tablet terminal, or the like in a wireless or wired manner via the communication I/F (interface) 14, and the pedal keyboard image and the like are displayed on the external display device by the external display device functioning in a similar manner to the display 6 shown and described in relation to the above-described embodiments.

According to one aspect of the aforementioned embodiment, the performance assistance apparatus includes: a display control section that causes a display device to display a foot operator image indicative of the foot operator group; an acquisition section that acquires model performance data designating a pitch to be performed; a determination section that determines whether the pitch designated by the acquired model performance data should be performed by use of the foot operator group; and a designation section that, upon determination that the designated pitch should be performed by use of the foot operator group, visually designates, on the foot operator image displayed on the display device, a particular foot operator of the plurality of foot operators that corresponds to the designated pitch.

According to another aspect of the aforementioned embodiment, a plurality of different pitches may be assigned respectively to the plurality of foot operators, and a manual operating section may include a manual operator group including a plurality of manual operators having different pitches assigned respectively thereto. A pitch range between the lowest pitch and the highest pitch of the plurality of different pitches assigned to the plurality of foot operators may be narrower than a pitch range between the lowest pitch and the highest pitch of the plurality of different pitches assigned to the plurality of manual operators. In such a case, the human player can easily operate the foot operator group with the foot, because the pitch range of the foot operator group is relatively narrow.

According to further aspect of the aforementioned embodiment, the manual operator group may be a manual keyboard that includes, as the plurality of manual operators, a plurality of manual keys having a plurality of pitches, constituting a chromatic scale, assigned respectively thereto, and the foot operator group may be a pedal keyboard that includes, as the plurality of foot operators, a plurality of pedal keys having a plurality of pitches, constituting a chromatic scale, assigned respectively thereto. In this case, the performance assistance apparatus effectively enables the human player to improve his or her skill for performing the pedal keyboard in an electronic musical instrument as typified by an electronic organ.

According to further aspect of the aforementioned embodiment, the performance assistance apparatus may further include a manual operator designation section that, upon determination by the determination section that the designated pitch should be performed by use of the manual operating section, designates a manual operator of the plurality of manual operators that corresponds to the designated pitch. In this case, the human player can easily know a manual operator to be operated as well as the foot operator to be operated. Thus, the human player is enabled to simultaneously improve the skill for performing the manual operator group and the skill for performing the foot operator group.

The foregoing disclosure has been set forth merely to illustrate the embodiments of the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A performance assistance apparatus for application to a performance apparatus provided with a foot operator group including a plurality of foot operators that are operable with a foot of a human player and that have different pitches assigned respectively thereto, the performance assistance apparatus comprising:
a storage medium storing a program; and
a processor for executing the program, the processor, when executing the program, configured to:
cause a display device to display a foot operator image indicative of the foot operator group;
acquire model performance data designating a pitch to be performed;
determine whether the pitch designated by the acquired model performance data should be performed by use of the foot operator group; and
upon determination that the designated pitch should be performed by use of the foot operator group, visually designate, on the foot operator image displayed on the display device, a particular foot operator of the plurality of foot operators that corresponds to the designated pitch.

2. The performance assistance apparatus as claimed in claim 1, wherein the processor is configured to visually designate the particular foot operator by adding a particular icon to the particular foot operator on the foot operator image displayed on the display device.

3. The performance assistance apparatus as claimed in claim 1, wherein the processor is configured to visually designate the particular foot operator by changing a display style of an image of the particular foot operator on the foot operator image displayed on the display device.

4. The performance assistance apparatus as claimed in claim 1, wherein the foot operator group provided in the performance apparatus is a pedal keyboard, and the processor is configured to cause the display device to display an image of the pedal keyboard as the foot operator image.

5. The performance assistance apparatus as claimed in claim 1, wherein the foot operator group provided in the performance apparatus is a pad-type operator group, and the processor is configured to cause the display device to display an image of the pad-type operator group as the foot operator image.

6. The performance assistance apparatus as claimed in claim 1, wherein the performance apparatus further includes a manual operating device operable with a hand of the human player, and wherein the processor is configured to determine which of the foot operator group and the manual operating device should be used to perform the pitch designated by the acquired model performance data.

7. The performance assistance apparatus as claimed in claim 6, wherein a plurality of different pitches are assigned respectively to the plurality of foot operators,
the manual operating device includes a manual operator group including a plurality of manual operators having different pitches assigned respectively thereto, and
a pitch range between a lowest pitch and a highest pitch of the plurality of different pitches assigned to the foot operators is narrower than a pitch range between a lowest pitch and a highest pitch of the plurality of different pitches assigned to the plurality of manual operators.

8. The performance assistance apparatus as claimed in claim 7, wherein the manual operator group is a manual keyboard that includes, as the plurality of manual operators, a plurality of manual keys having a plurality of pitches, constituting a chromatic scale, assigned respectively thereto, and
the foot operator group is a pedal keyboard that includes, as the plurality of foot operators, a plurality of pedal keys having a plurality of pitches, constituting a chromatic scale, assigned respectively thereto.

9. The performance assistance apparatus as claimed in claim 7, wherein the processor is further configured to, upon determination that the designated pitch should be performed by use of the manual operating device, designate a manual operator of the plurality of manual operators that corresponds to the designated pitch.

10. The performance assistance apparatus as claimed in claim 9, wherein the processor is further configured to cause the display device to display a manual operator image indicative of the manual operator group, and
wherein the processor is configured to, upon determination that the designated pitch should be performed by use of the manual operating device, designates, on the manual operator image displayed on the display device, a particular manual operator of the plurality of manual operator that corresponds to the designated pitch.

11. The performance assistance apparatus as claimed in claim 1, which includes the display device provided therein.

12. The performance assistance apparatus as claimed in claim 1, which includes a communication interface such that the performance assistance apparatus is capable of communicating with the display device provided outside the performance assistance apparatus.

13. A computer-implemented performance assistance method for application to a performance apparatus provided with a foot operator group including a plurality of foot operators that are operable with a foot of a human player and that have different pitches assigned respectively thereto, the performance assistance method comprising:
causing a display device to display a foot operator image indicative of the foot operator group;
acquiring model performance data designating a pitch to be performed;
determining whether the pitch designated by the acquired model performance data should be performed by use of the foot operator group; and
upon determination that the designated pitch should be performed by use of the foot operator group, visually designating, on the foot operator image displayed on the display device, a particular foot operator of the plurality of foot operators that corresponds to the designated pitch.

14. The performance assistance method as claimed in claim 13, wherein the particular foot operator of the plurality of foot operators is visually designated by adding a particular icon to the particular foot operator on the foot operator image displayed on the display device.

15. The performance assistance method as claimed in claim 13, wherein the particular foot operator of the plurality of foot operators is visually designated by changing a display style of an image of the particular foot operator on the foot operator image displayed on the display device.

16. The performance assistance method as claimed in claim 13, wherein the foot operator group provided in the performance apparatus is a pedal keyboard, and the foot operator image to be displayed on the display device is an image indicative of the pedal keyboard.

17. The performance assistance method as claimed in claim 13, wherein the foot operator group provided in the performance apparatus is a pad-type operator group, and the foot operator image to be displayed on the display device is an image indicative of a pad-type operator group operator.

18. The performance assistance method as claimed in claim 13, wherein the performance apparatus further includes a manual operating device operable with a hand of the human player, and wherein it is determined which of the foot operator group and the manual operating device should be used to perform the pitch designated by the acquired model performance data.

19. The performance assistance method as claimed in claim 18, further comprising designating a manual operator corresponding to the designated pitch upon determination that the designated pitch should be performed by use of the manual operating device.

20. A non-transitory machine-readable storage medium containing a program executable by a processor to perform a performance assistance method for application to a performance apparatus provided with a foot operator group including a plurality of foot operators that are operable with a foot of a human player and that have different pitches assigned respectively thereto, the performance assistance method comprising:
causing a display device to display a foot operator image indicative of the foot operator group;
acquiring model performance data designating a pitch to be performed;
determining whether the pitch designated by the acquired model performance data should be performed by use of the foot operator group; and
upon determination that the designated pitch should be performed by use of the foot operator group, visually designating, on the foot operator image displayed on the display device, a particular foot operator of the plurality of foot operators that corresponds to the designated pitch.
